(19) United States
(12) Patent Application Publication
(10) Pub. No.: US 2011/0024354 A1
(43) Pub. Date: Feb. 3, 2011

(54) DESALINATION SYSTEM AND METHOD

(75) Inventors: Jiyang Xia, Shanghai (CN); Rihua Xiong, Shanghai (CN); Wei Cai, Shanghai (CN); Zijun Xia, Shanghai (CN); Chengqian Zhang, Shanghai (CN); James Manio Silva, Clifton Park, NY (US); Weiming Zhang, Shanghai (CN)

Correspondence Address: JOHN M. HARRINGTON, 1001 WEST FOURTH STREET, WINSTON-SALEM, NC, 27101, US

(73) Assignee: GENERAL ELECTRIC COMPANY, SCHENECTADY, NY (US)

(21) Appl. No.: 12/512,324

(22) Filed: Jul. 30, 2009

(51) Int. Cl. C02F 1/469; C02F 1/58; C02F 5/02; C02F 5/06

(52) U.S. Cl. 210/648; 210/195.1; 210/195.2; 210/173; 210/712

(57) ABSTRACT

A desalination system comprises an electrical separation device configured to receive and ionize a first stream for desalination and a crystallization device. The crystallization device is configured to provide a second stream to the electrical separation device to carry away ions from the first stream, and defining a crystallization zone for facilitating precipitation of the ions and a solid-liquid separation zone in fluid communication with the crystallization zone for separation of the precipitate. A desalination method is also presented.

### BACKGROUND OF THE DISCLOSURE

The invention relates generally to desalination systems and methods. More particularly, this invention relates to desalination systems and methods using electrical separation (E-separation) elements.

In industrial processes, large amounts of wastewater, such as aqueous saline solutions are produced. Generally, such saline solutions are not suitable for direct consumption in domestic or industrial applications. In view of the limited eligible water sources, de-ionization or desaltification of wastewater, seawater or brackish water, commonly known as desalination, becomes an option to produce fresh water.

Different desalination processes, such as distillation, vaporization, reversed osmosis, and partial freezing are currently employed to de-ionize or desalt a water source. However, such processes can suffer from low efficiency and high energy consumption, which may prohibit them from being widely implemented.

Therefore, there is a need for a new and improved desalination system and method for desalination of wastewater or brackish water.

### BRIEF DESCRIPTION OF THE DISCLOSURE

A desalination system is provided in accordance with one embodiment of the invention. The desalination system comprises an electrical separation device configured to receive a first stream for desalination and a crystallization device. The crystallization device is configured to provide a second stream to the electrical separation device to carry away ions removed from the first stream, and defines a crystallization zone for facilitating precipitation of the ions. The crystallization device further defines a solid-liquid separation zone in fluid communication with the crystallization zone for separation of the precipitate.

A desalination method is provided in accordance with another embodiment of the invention. The desalination method comprises passing a first stream through an electrical separation device for desalination, and passing a second stream from a crystallization device through the electrical separation device to carry away salts removed from the first stream. The crystallization device defines a crystallization zone for facilitating precipitation of the ions and a solid-liquid separation zone in fluid communication with the crystallization zone for separation of the precipitate.

These and other advantages and features will be better understood from the following detailed description of preferred embodiments of the invention that is provided in connection with the accompanying drawings.

### BRIEF DESCRIPTION OF THE DRAWINGS

FIG. 1 is a schematic diagram of a desalination system in accordance with one embodiment of the invention;

FIG. 2 is a schematic diagram of the desalination system including a supercapacitor desalination (SCD) device and the crystallization device in accordance with one embodiment of the invention;

FIG. 3 is a schematic diagram of the desalination system in accordance with another embodiment of the invention;

FIG. 4 is a schematic diagram of the desalination system including an electrodialysis reversal (EDR) device and the crystallization device in accordance with one embodiment of the invention; and

FIG. 5 is a schematic diagram of the desalination system in accordance with yet another embodiment of the invention.

### DETAILED DESCRIPTION OF THE INVENTION

Preferred embodiments of the present disclosure will be described hereinbelow with reference to the accompanying drawings. In the following description, well-known functions or constructions are not described in detail to avoid obscuring the disclosure in unnecessary detail.

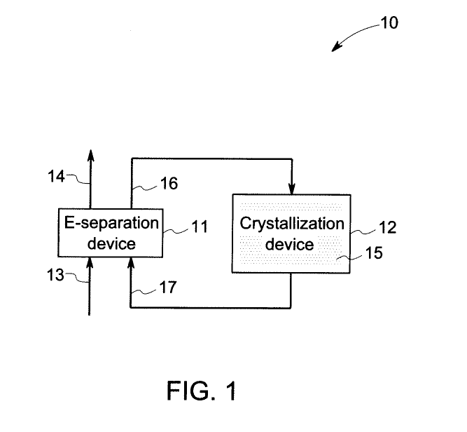

FIG. 1 is a schematic diagram of a desalination system 10 in accordance with one embodiment of the invention. For the illustrated example, the desalination system 10 comprises an electrical separation (E-separation) device 11 and a crystallization device 12 in fluid communication with the E-separation device 11.

In embodiments of the invention, the E-separation device 11 is configured to receive a first stream 13 (as shown in FIG. 1) having charged species, such as salts or other impurities from a liquid source (not shown) for desalination. Thus, an output stream (a product stream) 14, which may be a dilute liquid coming out of the E-separation device 11, may have a lower concentration of the charged species as compared to the stream 13. In some examples, the output stream 14 may be circulated into the E-separation device 11 or be sent into other E-separation devices for further desalination.

The crystallization device 12 is configured to provide a liquid 15 circulated into the E-separation device 11 during or after desalination of the first stream 13 so as to carry the charged species (anions and cations) removed from the input stream 13 out of the E-separation device 11. Thus, an outflow stream (a concentrated stream) 16 may have a higher concentration of charged species compared to a second stream 17 input into the E-separation device 11 from the crystallization device 12. As the circulation of the liquid 15 continues, the concentration of the salts or other impurities continually increases so as to be saturated or supersaturated in the liquid 15. As a result, the degree of saturation or the supersaturation may reach a point where precipitation begins to take place.

In certain applications, the initial (first) stream 13 and the initial (second) stream 17 may or may not comprise the same salts or impurities, and may or may not have the same concentration of the salts or the impurities. In other examples, the concentration of the salts or impurities in the initial (second) stream 17 may or may not be saturated or supersaturated.

In some embodiments, the E-separation device 11 may comprise a supercapacitor desalination (SCD) device. The term “SCD device” may generally indicate supercapacitors that are employed for desalination of seawater or deionization of other brackish waters to reduce the amount of salt or other ionized impurities to a permissible level for domestic and industrial use.

In certain applications, the supercapacitor desalination device may comprise one or more supercapacitor desalination cells (not shown). As is known, in non-limiting examples, each supercapacitor desalination cell may at least comprise a pair of electrodes, a spacer, and a pair of current collectors attached to the respective electrodes. A plurality of insulating separators may be disposed between each pair of adjacent SCD cells when more than one supercapacitor desalination cell stacked together is employed.

In embodiments of the invention, the current collectors may be connected to positive and negative terminals of a power source (not shown), respectively. Since the electrodes are in contact with the respective current collectors, the electrodes may act as anodes and cathodes, respectively.

During a charging state of the supercapacitor desalination device 11, positive and negative electrical charges from the power source accumulate on surfaces of the anode(s) and the cathode(s), respectively. Accordingly, when a liquid, such as the first stream 13 (as shown in FIG. 1) is passed through the SCD device 11 for desalination, the positive and negative electrical charges attract anions and cations in the ionized first stream 13 to cause them to be adsorbed on the surfaces of the anode(s) and the cathode(s), respectively. As a result of the charge accumulation on the anode(s) and the cathode(s), an outflow stream, such as the output stream 14 may have a lower salinity than the first stream 13. In certain examples, the dilute outflow stream may be subjected to de-ionization again by being fed through another SCD device.

Then, in a discharging state of the supercapacitor desalination device 11, the adsorbed anions and cations dissociate from the surfaces of the anode(s) and the cathode(s), respectively. Accordingly, when a liquid, such as the second stream 17 passes through the SCD device 11, the desorbed anions and cations may be carried away from the SCD device 11, so that an output liquid, such as the outflow stream 16 may have a higher salinity than the second stream 17. As the liquid is circulated to pass through the SCD device in the discharging state, the concentration of the salts or other impurities in the liquid 15 increases so as to produce precipitate. After the discharging of the SCD device is exhausted, the SCD device is then placed in a charging state for a period of time for preparation of a subsequent discharging. That is, the charging and the discharging of the SCD device are alternated for treating the first stream 13 and the second stream 17, respectively.

In certain examples, the energy released in the discharging state may be used to drive an electrical device (not shown), such as a light bulb, or may be recovered using an energy recovery cell, such as a bi-directional DC-DC converter.

In other non-limiting examples, similar to the SCD cells stacked together, the supercapacitor desalination device 11 may comprise a pair of electrodes, a pair of current collectors attached to the respective electrodes, one or more bipolar electrodes disposed between the pair of electrodes, and a plurality of spacers disposed between each of the pairs of adjacent electrodes for processing the first stream 13 in a charging state and the second stream 17 in a discharging state. Each bipolar electrode has a positive side and a negative side, separated by an ion-impermeable layer.

In some embodiments, the current collectors may be configured as a plate, a mesh, a foil, or a sheet and formed from a metal or metal alloy. The metal may include titanium, platinum, iridium, or rhodium, for example. The metal alloys may include stainless steel, for example. In other embodiments, the current collectors may comprise graphite or a plastic material, such as a polyolefin, which may include polyethylene. In certain applications, the plastic current collectors may be mixed with conductive carbon blacks or metallic particles to achieve a certain level of conductivity.

The electrodes and/or bipolar electrodes may include electrically conductive materials, which may or may not be thermally conductive, and may have particles with smaller sizes and large surface areas. In some examples, the electrically conductive material may include one or more carbon materials. Non-limiting examples of the carbon materials include activated carbon particles, porous carbon particles, carbon fibers, carbon aerogels, porous mesocarbon microbeads, or combinations thereof. In other examples, the electrically conductive materials may include a conductive composite, such as oxides of manganese, or iron, or both, or carbides of titanium, zirconium, vanadium, tungsten, or combinations thereof.

Additionally, the spacer may comprise any ion-permeable, electronically nonconductive material, including membranes and porous and nonporous materials to separate the pair of electrodes. In non-limiting examples, the spacer may have or itself may be space to form flow channels through which a liquid for processing passes between the pair of electrodes.

In certain examples, the electrodes, the current collectors, and/or the bipolar electrodes may be in the form of plates that are disposed parallel to each other to form a stacked structure. In other examples, the electrodes, the current collectors, and/or the bipolar electrodes may have varied shapes, such as a sheet, a block, or a cylinder. Further, the electrodes, the current collectors, and/or the bipolar electrodes may be arranged in varying configurations. For example, the electrodes, the current collectors, and/or the bipolar electrodes may be disposed concentrically with a spiral and continuous space therebetween. Other descriptions of the supercapacitor desalination device can be found in U.S. Patent application publication 20080185346, which is hereby incorporated by reference in its entirety.

For certain arrangements, the E-separation device 11 may comprise an electrodialysis reversal (EDR) device (not shown). The term “EDR” may indicate an electrochemical separation process using ion exchange membranes to remove ions or charged species from water and other fluids.

As is known, in some non-limiting examples, the EDR device comprises a pair of electrodes configured to act as an anode and a cathode, respectively. A plurality of alternating anion- and cation-permeable membranes are disposed between the anode and the cathode to form a plurality of alternating dilute and concentrate channels therebetween. The anion-permeable membrane(s) are configured to be passable for anions. The cation-permeable membrane(s) are configured to be passable for cations. Additionally, the EDR device may further comprises a plurality of spacers disposed between each pair of the membranes, and between the electrodes and the adjacent membranes.

Accordingly, while an electrical current is applied to the EDR device 11, liquids, such as the streams 13 and 17 (as shown in FIG. 1) pass through the respective alternating dilute and concentrate channels, respectively. In the dilute channels, the first stream 13 is ionized. Cations in the first stream 13 migrate through the cation-permeable membranes towards the cathode to enter into the adjacent channels. The anions migrate through the anion-permeable membranes towards the anode to enter into other adjacent channels. In the adjacent channels (concentrate channels) located on each side of a dilute channel, the cations may not migrate through the anion-permeable membranes, and the anions may not migrate through the cation permeable membranes, even though the electrical field exerts a force on the ions toward the respective electrode (e.g. anions are pulled toward the anode). Therefore, the anions and cations remain in and are concentrated in the concentrate channels.

As a result, the second stream 17 passes through the concentrate channels to carry the concentrated anions and cations out of the EDR device 11 so that the outflow stream 16 may be have a higher salinity than the input stream. After the circulation of the liquid 15 in the EDR device 11, the precipitation of the salts or other impurities may occur in the crystallization device 12.

In some examples, the polarities of the electrodes of the EDR device 11 may be reversed, for example, every 15-50 minutes so as to reduce the fouling tendency of the anions and cations in the concentrate channels. Thus, in the reversed polarity state, the dilute channels from the normal polarity state may act as the concentration channels for the second stream 17, and the concentration channels from the normal polarity state may function as the dilution channels for the first stream 13.

In some applications, the electrodes may include electrically conductive materials, which may or may not be thermally conductive, and may have particles with smaller sizes and large surface areas. The spacers may comprise any ion-permeable, electronically nonconductive material, including membranes and porous and nonporous materials. In non-limiting examples, the cation permeable membrane may comprise a quaternary amine group. The anion permeable membrane may comprise a sulfonic acid group or a carboxylic acid group.

It should be noted that the E-separation device 11 is not limited to any particular supercapacitor desalination (SCD) device or any particular electrodialysis reversal (EDR) device for processing a liquid. Moreover, the suffix “(s)” as used above is usually intended to include both the singular and the plural of the term that it modifies, thereby including one or more of that term.

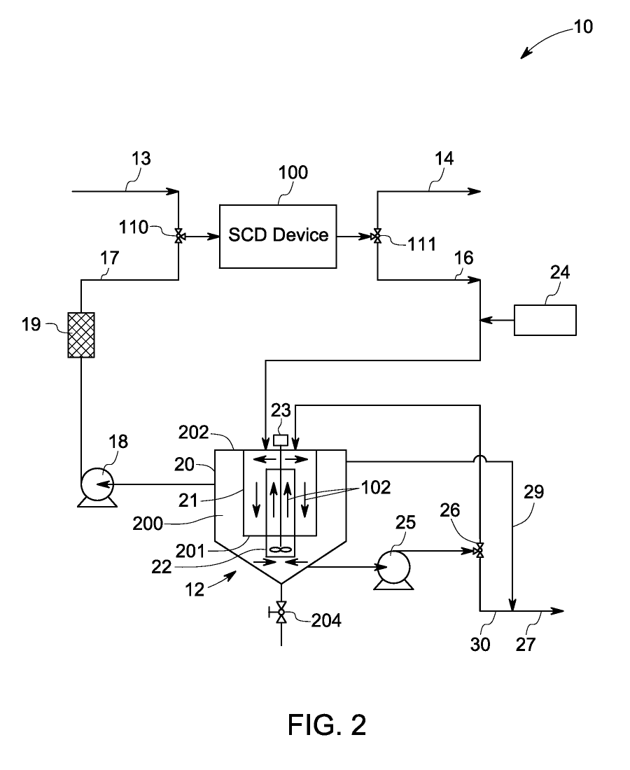

FIG. 2 is a schematic diagram of the desalination system 10 including a supercapacitor desalination (SCD) device 100 and a crystallization device 12. The same numerals in FIGS. 1-5 may indicate the similar elements.

For the illustrated arrangement, during a charging state, a first stream 13 from a liquid source (not shown) passes through a valve 110 and enters into the SCD device 100 for desalination. In this state, a flow path of an input stream 17 to the SCD device is closed in the valve 110. A dilute stream (a product stream) 14 flows from the SCD device 100 and passes through a valve 111 for use and has a lower concentration of salts or other impurities as compared to the first stream 13. In certain examples, the dilute stream may be redirected into the SCD device 11 for further processing.

In a discharging state, the second stream 17 is pumped by a pump 18 from the crystallization device 12, and passes through a filter 19 and the valve 110 to enter into the SCD device 100 to carry ions (anions and cations) therefrom, and an outflow stream 16 flows from the SCD device 100 and passes through the valve 111, and has a higher concentration of the salt or other impurities as compared with the second stream 17. In this state, the flow path of an input stream 13 to the SCD device is closed in the valve 110. Additionally, the filter 19 is configured to filter some particles to avoid clogging the SCD device 100. In certain applications, the filter 19 may not be provided.

As depicted in FIG. 2, the crystallization device 12 comprises a vessel 20 configured to define a containment zone (not labeled) to accommodate the liquid 15 (as shown in FIG. 1) and a crystallization element 21 defining a crystallization zone (not labeled) disposed within and in fluid communication with the containment zone. Thus, a solid-liquid separation zone 200 is defined between the crystallization element 21 and an outside wall of the vessel 20 for solid-liquid separation, so that a part of precipitate particles of the salts or other impurities may be separated by settling into a lower portion of the vessel 20 before the liquid 15 is circulated into the E-separation device, such as the SCD device 100 from the crystallization device 12.

In the illustrated embodiment, the bottom of the vessel 20 is cone-shaped. The crystallization element 21 has a hollow cylindrical shape to define the crystallization zone and comprises a lower opening 201 in communication with the vessel 20. In some non-limiting examples, the vessel 20 may have other shapes, such as cylindrical or rectangular shapes. Similarly, the crystallization element 21 may also comprise other shapes, such as rectangular or cone shapes. Additionally, an upper opening 202 in communication with the bottom opening 201 of the crystallization element 21 may or may not be provided to communicate with the vessel 20.

Accordingly, as illustrated in FIG. 2, the output stream 16 is redirected into the crystallization zone from an upper end (not labeled) of the crystallization element 21, and then dispersed into the solid-liquid separation zone 200 between the crystallization element 21 and the vessel 20 from the lower opening 201 and/or the upper opening 202 of the crystallization element 21 for solid-liquid separation and circulation. With the circulation of the liquid 15 between the SCD device 100 and the crystallization device 12, the precipitation of (formed by) the ions occurs and increases in the crystallization device 12 over time. Thus, the precipitate particles with diameters larger than a specified diameter may settle down in the lower portion of the vessel 20. Meantime, other precipitate particles with diameters smaller than the specified diameter may be dispersed in the liquid 15.

When the precipitation rate plus a blow down rate of a stream 27 during the discharge step equals the charged species removal rate during the charge step, the degree of saturation or supersaturation of the concentrate stream circulating between the SCD device and the crystallization device may stabilize and a dynamic equilibrium may be established.

For the illustrated embodiment, a confining element 22 is provided to define a confinement zone with at least a portion thereof disposed within the crystallization zone and in communication with the crystallization zone and the containment zone. In one example, the confining element 22 may comprise two open ends and have a hollow cylindrical shape to define the confinement zone. Alternatively, the confining element 22 may have other shapes, such as such as rectangular or cone shapes.

Additionally, an agitator 23 may be provided to extend into the confinement zone so as to facilitate the flow of the liquid 15 in the crystallization zone and the confinement zone. A flow direction of the liquid 15 agitated by the agitator 23 may be from top to bottom (as indicated by arrows 102) or from bottom to top.

In other examples, a device 25 including a pump may also be provided to direct a portion of the liquid 15 from the bottom portion of the vessel 20 to pass through a valve 26 and to enter into the crystallization zone so as to facilitate the flow of the liquid 15 in the crystallization zone and the confinement zone. Normally, the valve 26 blocks a flow path of a discharge (waste) stream 27. In certain examples, the device 25 may be further used to wear away particles in the portion of the liquid 15.

By the particle attrition in device 25, a portion of formed precipitate particles may be suspended in the liquid 15 to act as seed particles to increase the contact area between the particles and the salts or impurities therein to induce more precipitation on surfaces of the formed precipitate particles. In some examples, the confining element 22 may not be employed. Similarly, in particular examples, the agitator 23 and/or the pump 25 may also not be provided.

For the arrangement illustrated in FIG. 2, the crystallization zone and the solid-liquid separation zone are both defined within the same vessel 20. In some non-limiting examples, the crystallization zone and the solid-liquid separation zone may be spatially separated from each other.

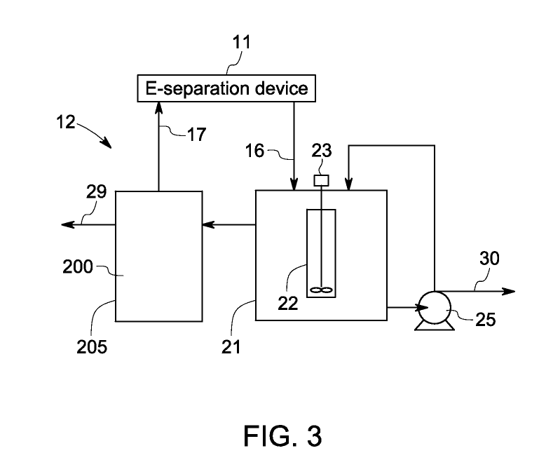

FIG. 3 is schematic diagram of the desalination system in accordance with another embodiment of the invention. For the ease of illustration, some elements are not depicted. For the illustrated arrangement, the crystallization device 12 comprises a crystallization element 21 defining the crystallization zone and a separation element 205 spatially separated from the crystallization element 21 and defining the solid-liquid separation zone 200.

Accordingly, similar to the arrangement illustrated in FIG. 2, the output stream 16 is redirected into the crystallization zone for facilitating the precipitation of the salts or other impurities, and then flows into the solid-liquid separation zone 200 to separate a portion of the precipitate from the liquid 15 before the liquid 15 is circulated into the E-separation device 11.

In some examples, the liquid 15 is originally accommodated into the crystallization element 21 and/or the separation element 25. The crystallization device 12 may comprise two or more spatially separated elements to define the crystallization zone and the solid-liquid separation zone, respectively. In certain examples, non-limiting examples of the separation element 205 for defining the solid-liquid separation zone may comprise a vessel, a hydrocyclone, a centrifuge, a filter press, a cartridge filter, a microfiltration, and an ultrafiltration device.

In some embodiments, the precipitation of the salts or other impurities may not occur until the degree of saturation or supersaturation thereof is very high. For example, CaSO₄ reaches a degree of supersaturation of 500% before its precipitation occurs, which may be disadvantageous to the system. Accordingly, in certain examples, seed particles (not shown) may be added into the vessel 20 to induce the precipitation on surfaces thereof at a lower degree of supersaturation of the salts or other impurities. Additionally, the agitator 23 and/or the pump 25 may be provided to facilitate suspension of the seed particles in the vessel 20.

In non-limiting examples, the seed particles may have an average diameter range from about 1 to about 500 microns, and may have a weight range from about 0.1 weight percent (wt %) to about 30 wt % of the weight of the liquid in the crystallization zone. In some examples, the seed particles may have an average diameter range from about 5 to about 100 microns, and may have a weight range from about 1.0 wt % to about 20 wt % of the weight of the liquid in the crystallization zone. In certain applications, the seed particles may comprise solid particles including, but not limited to CaSO₄ particles and their hydrates to induce the precipitation. The CaSO₄ particles may have an average diameter range from about 10 microns to about 100 microns. In some example, the equilibrium CaSO₄ seed particle loading may be in a range of from about 0.1 wt % to about 2.0 wt % of the weight of the liquid in the crystallization zone, so that the supersaturation of the CaSO₄ in the crystallization device 12 may be controlled in a range of from about 100% to about 150% in operation when CaSO₄ precipitation occurs.

In other examples, one or more additives 24 may be added into the outflow stream 16 to reduce the degree of saturation or supersaturation of some species. For example, an acid additive may be added into the outflow stream 16 to reduce the degree saturation or supersaturation of CaCO₃. In certain examples, the additives may or may not be added into the first stream 13.

It should be noted that the seed particles and the additives are not limited to any particular seed particles or additives, and may be selected based on different applications.

In certain examples, a certain amount of a stream 29 may be removed from the liquid 15 to maintain a constant volume and/or reduce the degree of saturation or supersaturation of some species in the vessel 20. The stream 29 may be mixed with a stream 30 removed from the bottom portion of the vessel 20 using the pump 25 to form the discharge (waste) stream 27.

In some examples, the stream 30 may comprise ten or more weight percent of the precipitate. For these examples, the valve 26 blocks the flow path for the circulation of the liquid 15. Additionally, a valve 204 may also be disposed on the lower portion to facilitate evacuating the vessel 20.

For the arrangement illustrated in FIG. 2, the stream 16 is fed into the vessel 20 from an upper portion of the vessel 20. Alternatively, the outflow stream 16 may be fed into the vessel 20 from the lower portion thereof. Other aspects of the desalination system 10 may be found in U.S. Patent application publication 20080185346, which is cited above.

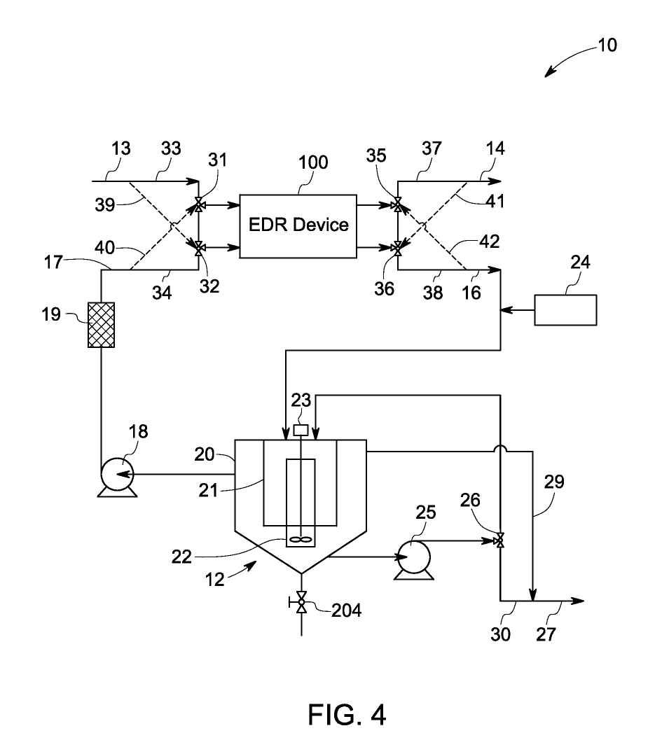

FIG. 4 is a schematic diagram of the desalination system including an electrodialysis reversal (EDR) device 101 and a crystallization device 12 in accordance with one embodiment of the invention. The arrangement in FIG. 3 is similar to the arrangement in FIG. 2. The two arrangements in FIGS. 2 and 3 differ in that the E-separation device comprises the EDR device 101.

Thus, in a state when the EDR device is at a normal polarity state, streams 13 and 17 from a liquid source (not shown) and a vessel 20 pass through first valves 31 and 32 along respective first input pipes, as indicated by solid lines 33 and 34 to enter into the EDR device 101. A dilute stream 14 and an outflow stream 16 pass through second valves 35 and 36 and to enter into respective first output pipes, as indicated by solid lines 37 and 38.

When the EDR device is in a reversed polarity state, the streams 13 and 17 may enter the EDR device 101 along respective second input pipes, as indicated by broken lines 39 and 40. The dilute stream 14 and the outflow stream 16 may flow along respective second output pipes, as indicated by broken lines 41 and 42. Thus, the input streams and the output stream may be alternately entered into respective pipes to minimize the scaling tendency.

When the precipitation rate plus the blow down rate of the stream 27 equals the removal rate of the charged species, the degree of saturation or supersaturation of the concentrate stream circulating between the EDR device and the crystallization device may stabilize and a dynamic equilibrium may be established.

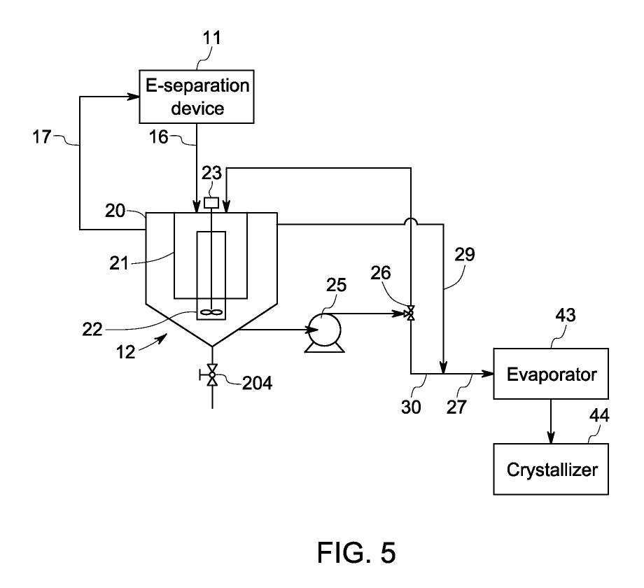

FIG. 5 is a schematic diagram of the desalination system 10 in accordance with another embodiment of the invention. For the ease of illustration, some elements are not depicted. As depicted in FIG. 4, the desalination system 10 may further include an evaporator 43 and a crystallizer 44 to evaporate and crystallize the discharge stream 27 so as to improve the stream usage and to achieve zero liquid discharge (ZLD). The evaporator 43 and the crystallizer 44 may be readily implemented by one skilled in the art. In one non-limiting example, the crystallizer 44 may be a thermal crystallizer, such as a dryer. In certain applications, the evaporator 43 and/or the crystallizer 44 may not be employed.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A desalination system comprising:
an electrical separation device configured to receive a first stream for desalination; and
a crystallization device configured to provide a second stream to the electrical separation device to carry away ions from the first stream, and defining a crystallization zone for facilitating precipitation of the ions and a solid-liquid separation zone in fluid communication with the crystallization zone for separation of the precipitate.

2. The desalination system of claim 1, wherein the crystallization device comprises a crystallization element defining the crystallization zone.

3. The desalination system of claim 2, wherein the crystallization device further comprises a vessel defining a containment zone, wherein the crystallization zone is disposed within and in fluid communication with the containment zone so that the solid-liquid separation zone is defined between the vessel and the crystallization element.

4. The desalination system of claim 2, wherein the crystallization device further comprises a confining element with at least a portion thereof disposed in the crystallization zone to define a confinement zone in fluid communication with the crystallization zone for facilitating the precipitation within the crystallization device.

5. The desalination system of claim 4, wherein each of the first and confining elements has a cylindrical shape.

6. The desalination system of claim 2, wherein the crystallization zone and the solid-liquid separation zone are spatially separated from each other.

7. The desalination system of claim 6, wherein the crystallization device comprises a separation element spatially separated from the crystallization element and defining the solid-liquid separation zone.

8. The desalination system of claim 7, wherein the solid-liquid separation element comprises one or more of a vessel, a settler, a cartridge filter, a filter press, a microfiltration device, a ultrafiltration device, a hydrocyclone, and a centrifuge.

9. The desalination system of claim 1, wherein the electrical separation device comprises a supercapacitor desalination device or an electrodialysis reversal device, wherein the supercapacitor desalination device receives the first stream during a charging state and receives the second stream during a discharging state, and wherein the electrodialysis reversal device receives the first stream and the second stream simultaneously.

10. The desalination system of claim 1, wherein the second stream comprises a saturated stream or a supersaturated stream.

11. The desalination system of claim 1, wherein the second steam is redirected into the crystallization device from the crystallization zone after passing through the electrical separation device so as to be circulated between the electrical separation device and the crystallization device.

12. The desalination system of claim 1, further comprising an agitator extending into the crystallization zone.

13. The desalination system of claim 1, further comprising a device in fluid communication with the crystallization device and configured to direct a part of the second stream out of and into the crystallization device.

14. The desalination system of claim 13, wherein the device is further configured to wear away particles in a part of the second stream.

15. The desalination system of claim 1, further comprising a plurality of seed particles disposed within the crystallization device to induce precipitation.

16. The desalination system of claim 15, wherein the seed particles have an average diameter range from about 1 micron to about 500 microns.

17. The desalination system of claim 15, wherein the seed particles have an average diameter range from about 5 micron to about 100 microns.

18. The desalination system of claim 15, wherein the seed particles have a weight range from about 0.1 weight percent (wt %) to about 30 wt % of a weight of the second stream in the crystallization zone.

19. The desalination system of claim 15, wherein the seed particles have a weight range from about 1.0 weight percent (wt %) to about 20 wt % of a weight of the second stream in the crystallization zone.

20. A desalination method comprising:
passing a first stream through an electrical separation device for desalination; and
passing a second stream from a crystallization device through the electrical separation device to carry away ions from the first stream, wherein the crystallization device is configured to provide the second stream to the electrical separation device to carry away ions from the first stream, and defining a crystallization zone for facilitating precipitation of the ions and a solid-liquid separation zone in fluid communication with the crystallization zone for separation of the precipitate.

21. The desalination method of claim 20, further comprising redirecting the second stream into the crystallization zone of the crystallization device after passing through the electrical separation device so as to circulate the second stream between the electrical separation device and the crystallization device.

22. The desalination method of claim 21, further comprising providing one or more additives into the second stream after the second stream passes through the electrical separation device to reduce a concentration of one or more species in the second stream.

23. The desalination method of claim 20, further comprising providing a plurality of seed particles into the crystallization device to facilitate precipitation of the ions.

24. The desalination method of claim 23, wherein the seed particles have an average diameter range from about 1 micron to about 500 microns, and wherein the seed particles have a weight range from about 0.1 weight percent (wt %) to about 30 wt % of a weight of the second stream in the crystallization zone.

25. The desalination method of claim 24, wherein the seed particles have an average diameter range from about 5 micron to about 100 microns, and wherein the seed particles have a weight range from about 1.0 wt % to about 20 wt % of a weight of the second stream in the crystallization zone.

26. The desalination method of claim 23, wherein the seed particles comprise CaSO₄ particles.

27. The desalination method of claim 23, further comprising suspending the seed particles in the crystallization zone.

28. The desalination method of claim 20, wherein the crystallization zone is disposed within and in fluid communication with the containment zone so that the solid-liquid separation zone is defined between the vessel and the crystallization element.

29. The desalination method of claim 20, wherein the electrical separation device comprises a supercapacitor desalination device or an electrodialysis reversal device, wherein the supercapacitor desalination device receives the first stream in a charging state and receives the second stream in a discharging state, and wherein the electrodialysis reversal device receives the first stream and the second stream simultaneously.

30. The desalination method of claim 20, wherein the crystallization device further comprises a confining element with at least a portion thereof disposed in the crystallization zone to define a confinement zone in fluid communication with the containment zone and the crystallization zone.
